(19) United States
(12) Patent Application Publication
(10) Pub. No.: US 2015/0283683 A1
(43) Pub. Date: Oct. 8, 2015

(54) HOLDING DEVICE FOR SCREWING IN A SCREW

(71) Applicant: FLACCOX S.L., Valencia (ES)

(72) Inventors: Ignacio Santiago ILZARBE RIPOLL, Valencia (ES); Juan GARCIA SANCHEZ, Valencia (ES); Luis Maria ILZARBE QUEROL, Valencia (ES); Jose Javier GONZALEZ MICO, Valencia (ES)

(73) Assignee: FLACCOX S.L., Valencia (ES)

(21) Appl. No.: 14/676,451

(22) Filed: Apr. 1, 2015

(30) Foreign Application Priority Data
Apr. 8, 2014 (ES) 201400325

(51) Int. Cl. B25B 23/10

(52) U.S. Cl. CPC B25B 23/10

(57) ABSTRACT

The present invention relates to a holding device for screwing in a screw, which relates to a device used to facilitate screwing a screw into a surface by means of an electric or manual screwdriver. The device comprises a continuous body with a characteristic outer surface and a bore communicating a top opening with a bottom opening of the body, the bore having a series of elastic longitudinal ribs. The device facilitates the positioning, tightening, guidance and release of the screw and the screwdriver, even in hard-to-reach places.

### OBJECT OF THE INVENTION

The present invention, a holding device for screwing in a screw, relates to a device used to facilitate screwing a screw into a surface by means of an electric or manual screwdriver, having a single tip or an interchangeable tip. The device comprises a continuous tubular longitudinal body with an outer surface and a cavity communicating a top opening with a bottom opening of the body, said cavity having longitudinal ribs and the device being made of an elastic material. The device facilitates the positioning, tightening, guidance and release of the screw and the screwdriver, even in hard-to-reach places.

The invention is primarily comprised in the field of do-it-yourself projects, and it can also be used in the field of toys, and particularly for screwing or driving in screws with a screwdriver.

### STATE OF THE ART

Different solutions that seek to facilitate screwing a screw into a surface are known in the state of the art, those solutions including different alternatives and possibilities. A user that wants to drive or screw a screw into a surface by means of an electric or conventional screwdriver usually does not want the screwdriver tip or blade to separate from the head of the screw to thus allow said screwing or driving thereof. This is particularly necessary when the surface of application of the screw is vertical or is below the screwdriver, because the user must hold the screw with one hand while holding the screwdriver with the other hand at the same time, applying pressure on the screw while turning it at the same time. Under these conditions, the user can encounter different complicated situations, such as holding the screw with one hand for example, hard-to-reach, hidden places, such as the inside a drawer for example, or surfaces of application that require using ladders, whereby compromising stability, possibly leading to the screw falling and the subsequent uncontrolled movement of the screwdriver tip, damaging the surface of application of the screw or an adjacent surface. A device or system that allows driving or screwing a screw into a surface one-handedly, i.e., without needing to hold the screw with one hand for screwing it into the surface of application and preventing the tip of the screwdriver from coming uncoupled, maladjusted or coming out of the head of the screw during the screwing operation, is therefore of particular interest.

To solve the preceding problems, different alternatives that seek to solve such problems are known in the state of the art. The most well known or most common solution is the use of screwdrivers with a magnetized tip for achieving a contact force between the screw and the screwdriver that prevents having to hold the screw with one hand for application thereof. These devices require the screw to have magnetic properties so that the screwdriver can solve the problem of facilitating the screwing or driving of a screw, and not all screws have those features because they may be manufactured from various non-ferromagnetic materials. These devices are also relatively expensive because they comprise independent accessories that are acquired separately or, as mentioned, they include a magnetized tip which, compounded with the public's unawareness of the functionality thereof and the public's rejection of magnetic devices, does not make them a highly valued alternative in the field.

In addition to the previous solution, there are others using additional devices intended for allowing the temporary or contact coupling of the tip of the screwdriver and the head of the screw during the screwing process, facilitating contact between both. Said devices usually have as a common element a tubular body inside which the tip of the screwdriver and the screw are connected during part of the screwing process. Devices from of the state of the art require inserting the head of the screw through one end of the tube and inserting the tip of the screwdriver through the opposite end.

Patent application GB2234695 describes a rigid tubular accessory that is coupled to the tip of a screwdriver at one end and the head of a screw is placed at the opposite end, the screwdriver tip fitting in said head. To allow coupling to the screwdriver, the device comprises a longitudinal groove allowing the partial opening of the device. Both the screwdriver and the screw are held inside the cylindrical tool due to friction between the different elements, assuring reliable mechanical holding that prevents the screw and the screwdriver from separating. The main problem with this accessory is that it only holds the screw by its head and does not apply pressure on the thread of the screw, which may cause the screw to come out of its housing in the device due to lateral movement, the screwdriver and the screw therefore becoming decoupled. The foregoing is accentuated because holding the head of the screw against the device is performed through rigid means that do not allow absorbing the differences in dimension between screwdriver tips and screw heads, which reduces and limits use because there are different types of screwdrivers and screws on the market.

Other examples of devices that require inserting the screwdriver at one end of the device and holding at the opposite end the head of the screwdriver through two opposite points by means of different holding means are U.S. Pat. No. 6,116,125 and U.S. Pat. No. 7,757,590. Another example is U.S. Pat. No. 6,128,982 which describes an example of a spring-loaded screwdriver which, among other features, comprises a tube acting as a screw guide and a washer to fix the head of said screw in the tube before screwing it into the surface of application.

A final solution is described in U.S. Pat. No. 4,526,072 which, in addition to allowing the insertion of the screw and the screwdriver at opposite ends in a device intended for facilitating driving, also allows insertion at the same end by guiding the screw throughout the entire device with the aid of the screwdriver. To make the guidance possible and to apply a tightening force along the path of the screw holding same, this device has a large number of bristles arranged in the cavity of the device. However, the pressure exerted by the bristles on the screw and screwdriver is not constant but depends on the positioning of the bristles once the screw is inserted therein, the eventual deformation of said bristles and therefore the pressure they will exert being unpredictable, varying in every driving operation. In any case, in the random event that the device behaves in accordance with the patent document, the exerted force would be constant and would not adapt to the efforts required during the screwing operation. Likewise, when turning the screwdriver-screw assembly inside the device, said bristles will also turn which can cause shifts in forces or even cause the bristles to wrap around the thread of the screw. Likewise, the bristles can be trapped between the head of the screw and the tip of the screwdriver, which can cause bristle detachment, breakage and unwanted stresses causing tube deformation while screwing in the screw. Said bristles can also be trapped between the head of the screw and the screwing surface, which would make partially unscrewing the screw to subsequently screw it in again necessary. In addition to the foregoing, manufacturing the device with two different types of materials for the bristles and the body of the tube considerably complicates manufacture thereof.

The device object of the present invention solves the mentioned problems present in the devices of the state of the art and facilitates the driving or screwing action in its positioning, contacting, initial tightening, guidance and release phases, when it is used with both a conventional screwdriver and an electric screwdriver.

### DESCRIPTION OF THE INVENTION

To solve the mentioned problems the present invention proposes a holding device for screwing in a screw comprising features aimed at solving the problems existing in the devices known in the state of the art.

Specifically, the first object of the invention is a holding device for screwing in a screw according to claim 1. Said device comprises a single tubular body with a cavity made of an elastic material which comprises, forming part of said body, longitudinal ribs in the cavity of the tubular body, said ribs which are also elastic and made of the same material extending or projecting towards the inside of said cavity and along almost the entire longitudinal extent of the surface of the cavity. The term longitudinal refers to the length of the device, i.e., the height thereof, in the sense that the ribs are located in the cavity and run along almost the entire length of said cavity.

The number of ribs will be adapted to the different metrics of the screws, although the minimum number is preferably 5, such that radial symmetry is assured in such a way that it provides a balance of forces for the correct operation of the elastic tool. Likewise, said ribs preferably have a curvature with respect to the surface of the cavity, i.e., the ribs are preferably not radial and straight but slightly curved. The ribs are attached to the surface of the cavity of the body of the device on one side and have another free side, like slats.

In addition to being elastic, the material of the device can also be an insulating material, making the use thereof in electrically hazardous places possible.

The objective of said device is to facilitate screwing a screw into a surface when operating a conventional manual or electric screwdriver acting on the head of the screw. To that end, the device comprises the mentioned inner elastic ribs arranged on the surface of the cavity the purpose of which is to facilitate the driving action in its different positioning, contacting or adjustment, initial tightening, guidance and release phases.

In the positioning phase, the thread of the screw is inserted in the cavity of the device through an inlet opening at the top base of the device, such that the screw is positioned by the action of the ribs holding it and by the opening of the device which is beveled to facilitate inserting the screw in the device. To hold the screw inside the device, the diameter of the head of the screw is always larger than the inner diameter of the cavity. Said inner diameter is the fictitious connection of the free sides of the ribs determining imaginary diameters at different longitudinal points. Said imaginary diameters may or may not be the same along the length of the cavity of the device.

The tip of the screwdriver is then positioned in, adjusted in or contacted with the head of the screw. Depending on the dimensions of the screw, a holding device with one diameter or another will be provided, although preferably one and the same device can be used with screws of different diameters as a result of the flexibility and elasticity of its components.

Subsequently and after the screw has contacted with the screwdriver and the tip of the screwdriver has been inserted by pressure in the device, both elements, i.e., the screw and screwdriver, are fixed inside the device and the assembly, particularly the tip of the screw, is ready to be placed against the surface. Therefore and as a result of the ribs of the device, the screwdriver-screw assembly can be fixed together for placing the assembly against the driving surface and for tightening the screw on said surface by means of turning the screwdriver.

Due to the ribs, which provide a contact surface between the screw-screwdriver assembly and the device, correct centering and guidance of the screw and screwdriver throughout the entire screwing process is assured and facilitated, making the process simpler for users. Due to the flexibility of the ribs, the pressure exerted by the ribs on the screw-screwdriver assembly is only applied when necessary, such that as the screw is gradually inserted in the surface, the device stops exerting pressure and therefore stops hindering the screw and the screwdriver from moving forward, making the guidance of the screw while driving said screw in and the subsequent release thereof once it has been driven in possible.

The screw is therefore released from the device before exiting same because, in addition to the fact that the force is adapted, the ribs do not extend to the bottom base of the device, said device being housed in the screwdriver and the screw being screwed in at the point of application thereof.

The outer geometry of the device, which is a single body made of the same elastic material, uniformly dissipates or distributes the torque produced when turning the tool inside the device as a result of turning the screwdriver and through the friction between the tool and the ribs combined with the grip of the base of the device with the driving surface.

In this sense, and to reduce the torque and thus prevent the device from winding around itself, assuring its functionality, the bottom portion of the device has a larger diameter than the diameter of the rest of the device, with the main objective of separating the support area of the device from the torsion center corresponding with the point of application of the screw. The contact and support surface can therefore be separated from the torsion center, thus generating greater moment of turn resistance. Another objective of the larger diameter in this portion is to allow the head of the screw to pass with greater ease at the moment close to the end of screwing in the screw.

With respect to surface finish and to reduce friction of the bottom base with the driving surface, this support area of the bottom base has a fine finish such that it has minimal roughness.

The second portion has a frustoconical configuration as a transition portion and to adapt the diameter of the first portion and the diameter of the third portion. Said portion concentrates and channels the generated forces, uniformly transferring the torsional loads between the faces forming the third portion. The overall torsion produced on the device therefore does not result in excessive device deformations.

The device can externally have ribbings or reinforcements that contribute to redirecting surface tensions to non-problematic areas. These ribbings or reinforcements provide greater rigidity because they increase the section in several areas of the geometry of the device, so the rigidity of the section to be twisted increases with respect to the common section of the remaining device. Said reinforcements are arranged outside the body in a number adapted to the diameter of the device, preferably 3, and extend longitudinally from the bottom base to the top base, the section thereof preferably decreasing as they approach said top base. Said reinforcements can have different finishes, such as half-spheres or grooves, for example. The objective of these reinforcements is to concentrate stresses and to release same into the body main which was what supported said stresses as described above. These reinforcements are particularly applicable in those devices that will be used with electric screwdrivers applying continuous torque and therefore generating continuous torsional stresses on the device, demanding greater resistance. In contrast, the torque applied by conventional screwdrivers is less demanding as it is intermittent as a result of being applied manually, outer reinforcements therefore not being necessary.

Likewise, and depending on the type of screwdriver to be used, the device suitably has one inner configuration or another.

Those devices that will be used with a conventional or electric screwdriver without variation between the diameter of the tip and the shaft preferably have a variable longitudinal section that increases progressively from the top part to the bottom part of the device, and with a larger section in the central area of the rib than at the ends thereof and the free side of the rib, opposite the surface of the cavity, therefore determining a curve. The thickness or width of the rib is constant, however the height of the rib with respect to the surface of the cavity increases and then decreases again. This configuration facilitates the entry and exit of the screw to/from the device, and the ribs exert maximum pressure in the central area thereof.

In contrast, when the device will be used with screwdrivers provided with a tool holder for interchangeable tips, which screwdrivers can also be electric or manual screwdrivers, the elastic ribs have a warped fin shape in the screwing direction of rotation. These fins, combined with the properties of the material, allow the adaptation thereof to different devices with different geometries, allowing adapting the inside of the device to transitions between different elements having different diameter, such as when there co-exist a screw, an interchangeable driving tip and the tool holder, drill holder or tip holder, which is the element holding said interchangeable tip and having a diameter larger than said tip and usually also larger than the head of the screw. In the case of an electric screwdriver, this tool holder is the rotating element of the screwdriver. In these cases, the device object of the invention must keep the different elements or components having different diameters in place. The tool holders supporting interchangeable tips usually have a diameter of about 10 mm, which makes a device absorbing the difference between the diameter of the tool holder and the diameters of the interchangeable tip and the screw necessary. Said difference in diameters is absorbed as a result of the elastic ribs with a warped fin shape acting as a spring system that absorbs the differences between the different diameters. Likewise, said ribs also have a smooth entry and exit transition to facilitate entry of the tool and exit of the screw.

On the other hand, as mentioned, in the case of electric screwdrivers a constant torque usually greater than that transmitted in the cases of manual screwdrivers is transmitted to the screw, so the devices in these cases preferably have reinforcements on their outer surface that cause an increase in section and also favor force compensation preventing the device from undesirably winding around itself.

The ribs can also have a longitudinal notch close to the surface of the cavity. Said notch can have different configurations, for example with a V-shaped profile or a U-shaped profile, although it may also have other configurations. This notch allows assuring correct operation of the device because once a specific number of uses in which the material can lose its properties is exceeded, the ribs will separate from the surface of the cavity, making the future use thereof impossible.

### DESCRIPTION OF THE DRAWINGS

To complement the description that is being made and for the purpose of aiding understanding of the features of the invention, a set of drawings is attached to the present specification in which the following has been depicted with an illustrative and non-limiting character:

FIG. 1 shows a perspective view of a first embodiment of the invention.

FIG. 2 shows a plan elevational view of the first embodiment and a detail of the projection of the rib with respect to the inner surface of the cavity.

FIG. 3 shows a section of the first embodiment.

FIG. 4 shows a sectional perspective view of the first embodiment.

FIG. 5 shows a perspective view of a second embodiment of the invention.

FIG. 6 shows a plan elevational view of the second embodiment and a detail of the projection of the rib with respect to the inner surface of the cavity.

FIG. 7 shows a section of the second embodiment.

FIG. 8 shows a sectional perspective view of the second embodiment.

FIG. 9 shows a pre-assembly view of a device object of the invention according to the second embodiment, together with a screw and a screwdriver with an interchangeable tip, a tool holder and a handle.

FIG. 10 shows a screw inserted in a device object of the invention.

FIG. 11 shows a screw and an interchangeable tip on a tool holder of a screwdriver inserted in a device object of the present invention.

### PREFERRED EMBODIMENTS OF THE INVENTION

The object of the present invention, a holding device for screwing a screw into a surface with the collaboration of a screwdriver, will be described below in reference to the drawings mentioned above according to two embodiments.

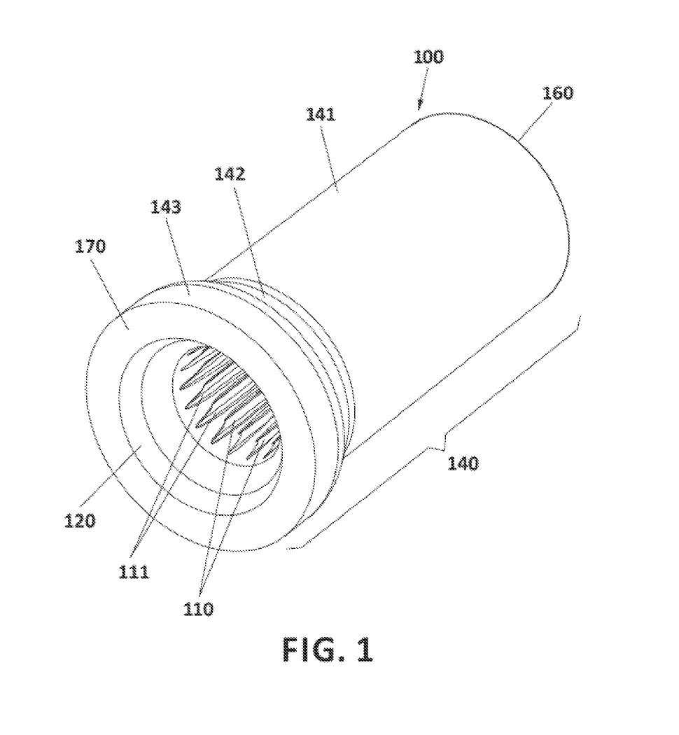

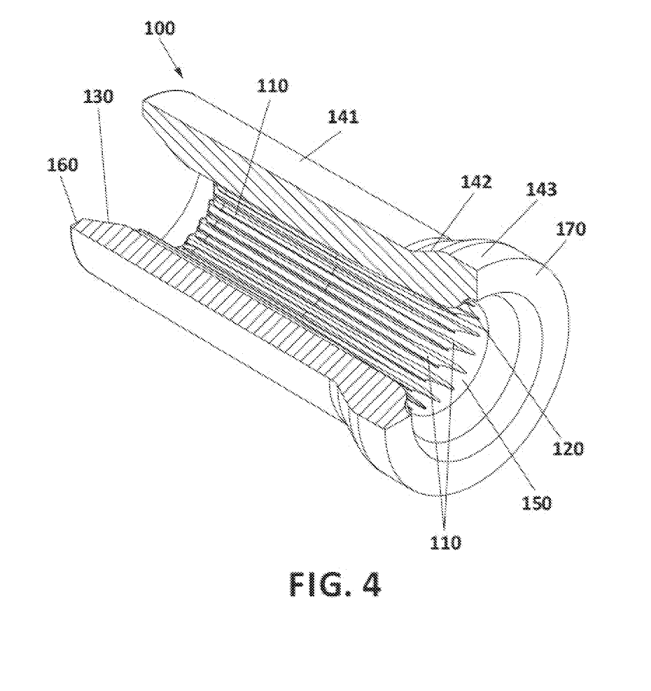

FIGS. 1 to 4 show a first embodiment relating to a holding device for screwing in a screw preferably by means of a manual or electric screwdriver consisting of a handle, a shaft and a tip, there being no difference between the diameter of the shaft and the tip.

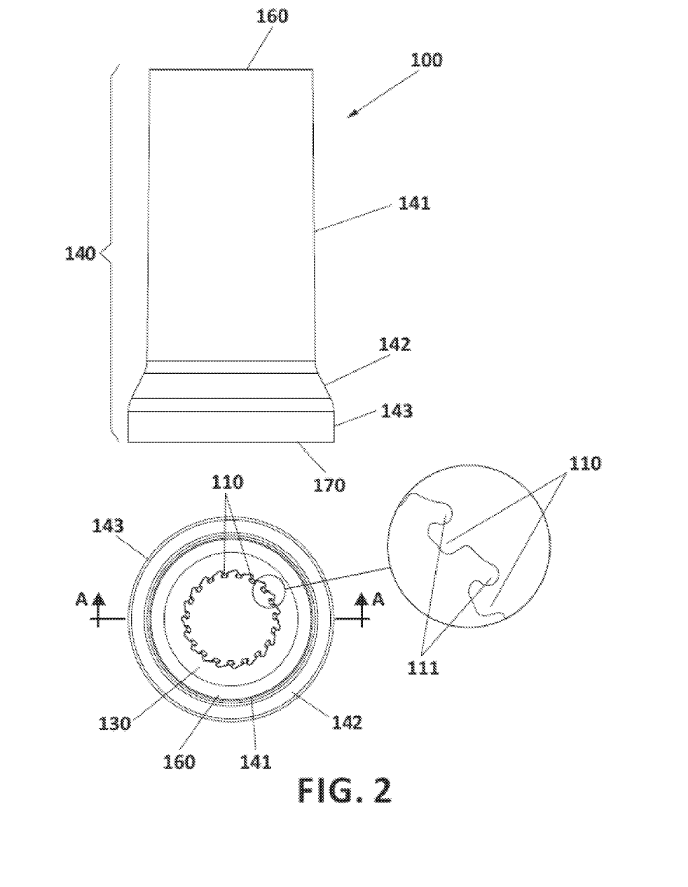

The holding device comprises a tubular body 100 with a cavity 150 provided with elastic ribs 110 extending longitudinally along almost the entire length of the cavity. Said ribs 110 are slightly curved with respect to the surface of the cavity 150 to facilitate entry of the screw and the screwdriver, as can be seen in the enlarged detail of FIG. 2.

The body 100 comprises an approximately frustoconical outer surface 140, with a bottom base 170 having a larger diameter than the top base 160. Specifically, the outer surface preferably determines three portions: a first bottom portion 143 having a constant diameter and starting at the bottom base 170 of the device 100; a third top portion 141 starting at the top base 160 and extending in such a way that it increases slightly towards the bottom base; and a second intermediate portion 142 connecting both preceding portions 141, 143. Said third top portion 141 is longer than the other two portions, the length of said top portion being close to the entire length of the device 100, or in other words, slightly less than the entire length of said device 100. The two bottom portions, the first portion 143 and the second portion 142, give the device a flared shape.

In addition to comprising the mentioned longitudinal ribs 110, the inner cavity comprises a countersunk configuration 130 in the opening for accessing the cavity arranged at the top base 160, such that the diameter of said opening gradually decreases towards the inside of the cavity, preferably having a 60° inclination. Said countersinking or bevel 130 enables easy entry of the screw into the device 100 by forcing it to be centered inside the cavity and furthermore allowing the adaptation of the device to screws with different head types.

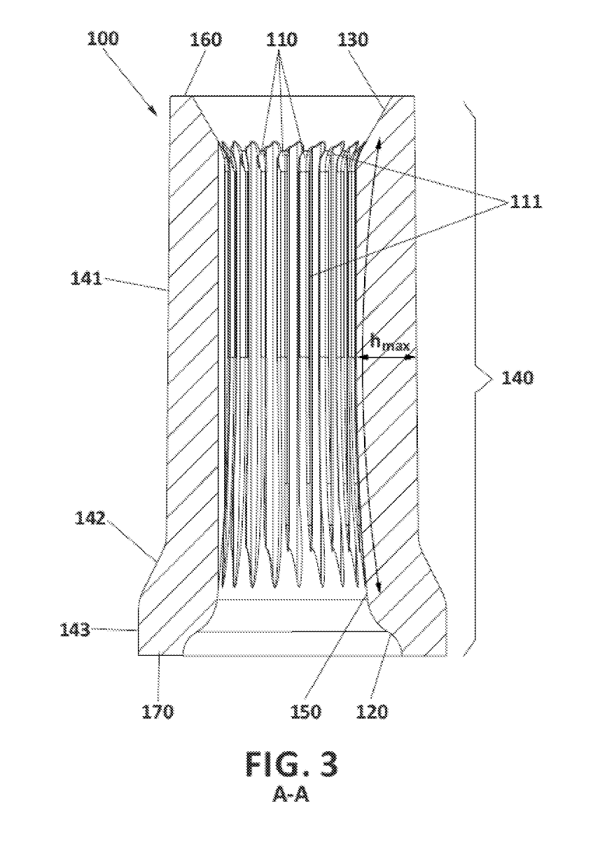

FIG. 3 shows a section of the device through one of said ribs, such that the curvature (c) of the rib 110 which causes a transition in the forces applied on the screw from its entry into the cavity of the device 100 is shown. As the progressive continuation of the bevel 130, the ribs 110 have a slight increase in height with respect to the surface of the cavity, or width in the radial direction, which starts to decrease again after reaching a maximum height (hmax). The transitions of the screw during entry and exit to/from the device are therefore smooth. Once the point of maximum height (hmax) of the ribs is exceeded, the height progressively decreases to facilitate the release of the screw as it exits and to prevent the device from winding around itself. This is because the final moments of screwing the screw into the surface require greater force for driving it in, which may cause the device 100 to wind around itself in the event that the ribs maintain the maximum height (hmax) during the exit of the device 100.

The ribs 110 have notches 111 at their base in connection or contact with the surface of the cavity 150 assuring correct operation of the device because once a specific number of uses in which the material can lose its properties is exceeded, the ribs 110 will separate from the surface of the cavity 150 due to the elastic and flexible material breaking.

The ribs 110 preferably do not extend to the bottom portion 143 but end before reaching the bottom base 170, such that the surface of the cavity 150 continues on to have an increased diameter in correspondence with the first bottom portion 143 of the outer geometry 140, giving the bottom opening 120 of the cavity a flared shape.

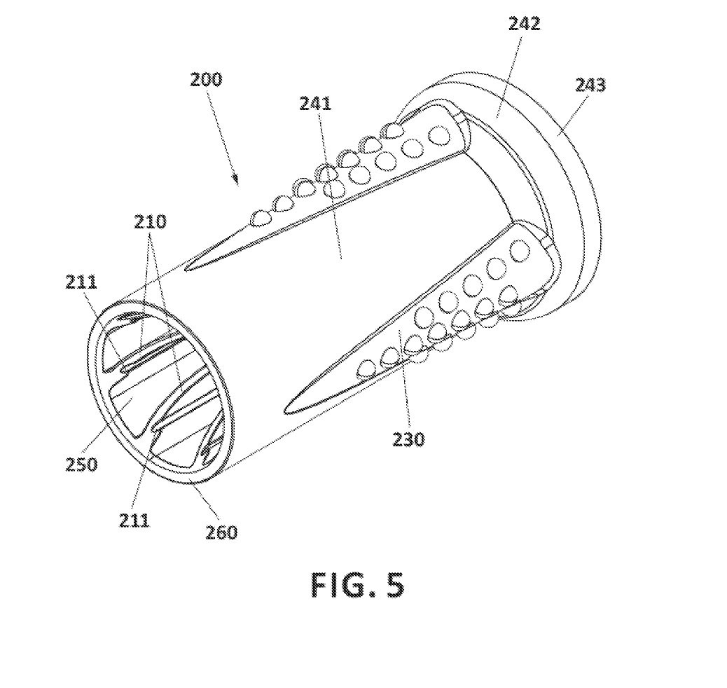

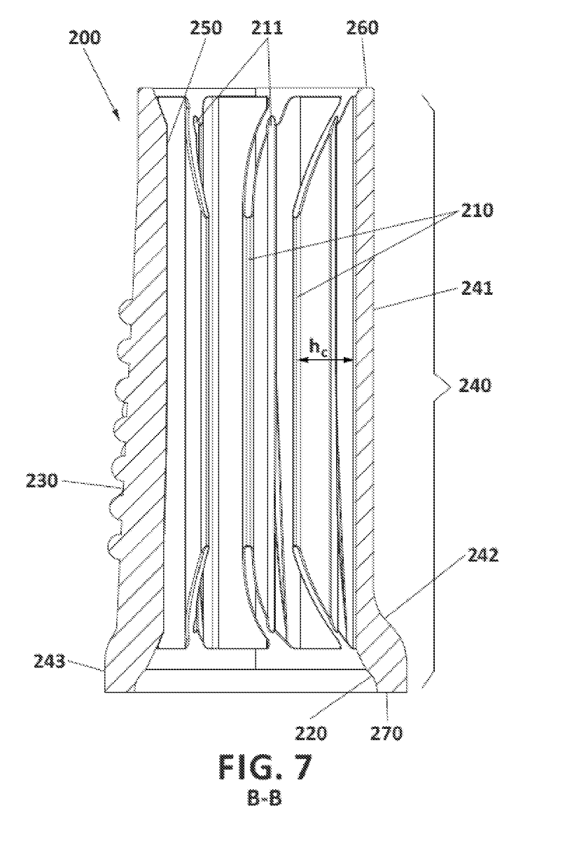

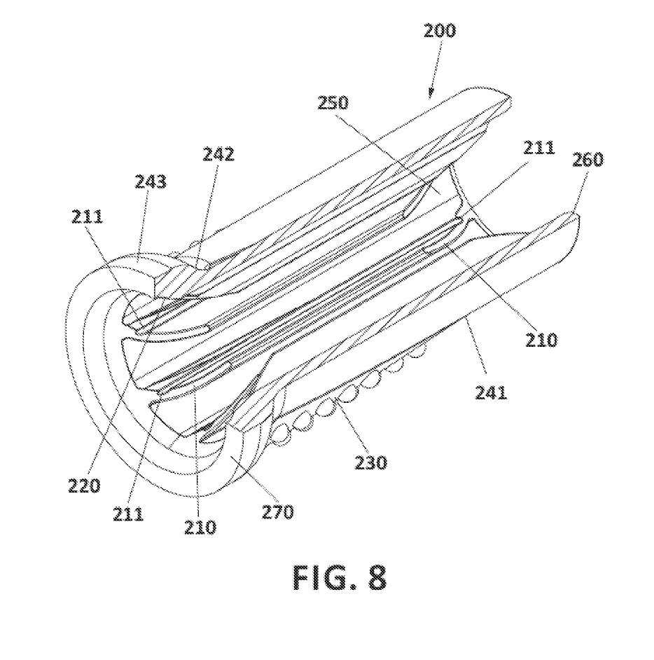

The second embodiment shown in FIGS. 5 to 8 relates to a holding device for screwing in a screw preferably by means of a manual or electric screwdriver with an interchangeable tip 40 usually consisting of a longitudinal or gun-shaped handle 42, a rotary tool holder 43 and an interchangeable tip 41 on said tool holder 43. The tool holder 43 and the interchangeable tip 41, together with the head 31 of the screw 30, require ribs 210 that correctly adapt to the variations in diameters, specifically between the tool holder 43 and the interchangeable tip 41, as well as between the interchangeable tip 41 and the head 31 of the screw.

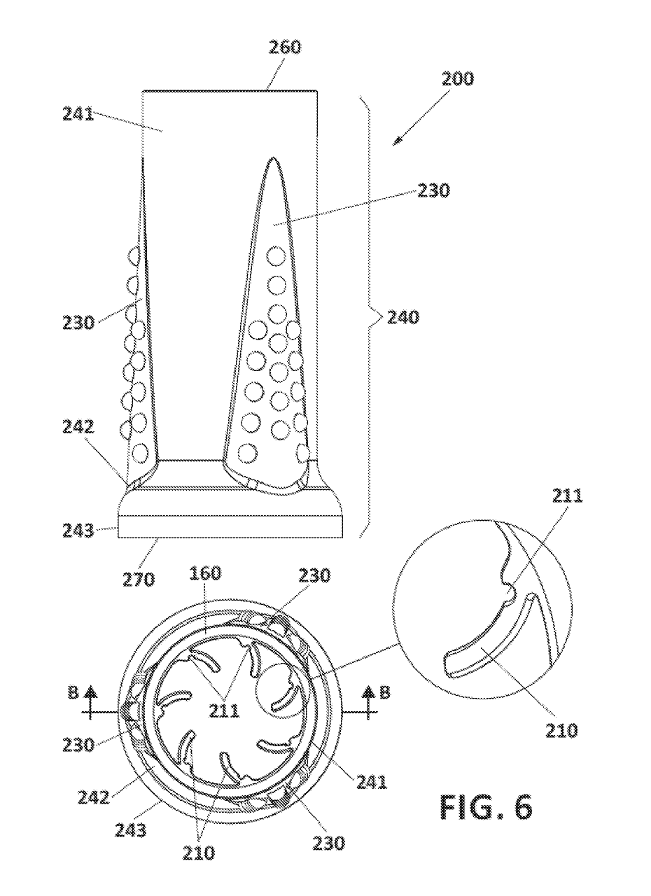

The main difference with the earlier device lies in the shape of the elastic ribs 210, and in this example said ribs 210 have a fin shape that is warped in the screwing direction of rotation. FIG. 6 and particularly the enlarged detail thereof show a section of the device 200 where the curve determined by said ribs 210 is seen. Said ribs also have a notch 211 at the base of the rib and close to the surface of the cavity 250 of the device to allow separation of the rib 210 from the surface of the cavity 250 when the device 200 cannot assure correct operation.

Therefore, the holding device comprises a tubular body 200 with a cavity 250 provided with elastic ribs 210 extending longitudinally along almost the entire length of the cavity. The ribs 210 have a slight increase in height or width in the radial direction from the opening of the top base 260 until reaching a constant height or width (hc), such that the screw 30 and the tool holder 43 of the screwdriver 40 both enter the cavity of the device 200 smoothly. The tool holder 43 is usually the element having a larger diameter in the assembly of the screwdriver 40. Said length of the ribs 210 in the radial direction decreases again close to the bottom base 270 to facilitate the release of the screw 30.

As described, the fin-shaped elastic ribs 210 allow the adaptation thereof to the different shapes of the elements making up the assembly forming the screwdriver 40 having an interchangeable tip, with its tool holder and tip and the screw, such that the ribs 210 absorb the transitions between the different geometries by bending and recovering their shape after the obstacle formed by each element due to the elasticity and flexibility of the material. The ribs 210 keep the different elements or components, i.e., the screw 30 and the components of the screwdriver 40 having an interchangeable tip, in place.

The body 200 comprises an outer frustoconical surface 240 similar to the device 100 described above, i.e., with a bottom base 270 having a larger diameter than the top base 260. Said outer surface also determines three portions: a first portion 243, a third portion 241 and a second portion 242 connecting the preceding portions. The two bottom portions 243, 242 give the device a flared shape. The third portion 241 preferably has a constant diameter along its length, although it can also increase progressively from the top base 260 to the bottom base 270.

This device 200 has reinforcements 230 on its surface, the function of which is to distribute the forces caused by the torsion generated due to the constant torque applied by the screwdriver when it is an electric screwdriver having an interchangeable tip in this case. Said reinforcements can have different outer finishes, for example half-spheres or grooves or other reliefs, and are desirable in the devices object of the invention that can be used with electric screwdrivers, i.e., those applying a constant torque.

The device 200 internally has an increased diameter at the bottom part thereof and on the inner surface, giving the bottom opening 220 a flared shape.

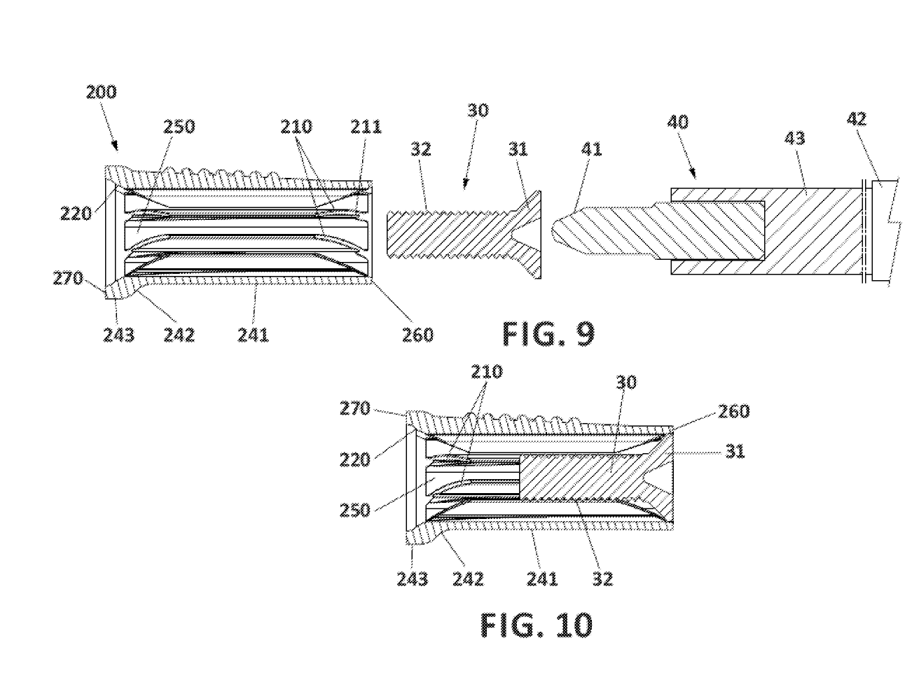

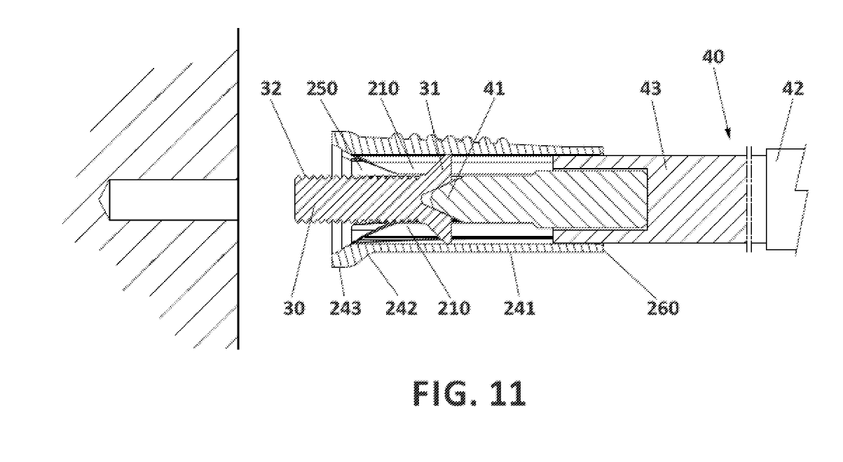

An example of using and operating a device object of the invention according to the described second embodiment, i.e., a holding device 200 to be used with a screw 30 and an electric or manual screwdriver 40 having an interchangeable tip comprising a handle 42, a tool holder 43 and an interchangeable tip 41, is described below in reference to FIGS. 9 to 11. The tool holder 43 can be connected with the handle 42 by means of a connecting shaft or the tool holder 43 itself can extend such that it reaches the handle 42, neither alternative affecting the present invention.

The screw 30 is first placed in the device 200, holding each of them with one hand, such that the thread 32 of the screw is inside the device 200. Said screw 30 can even go through the device 200 such that the thread protrudes through the bottom base 270 of the device 200, but the head 31 of the screw is always supported or fitted in the top part of the ribs 210 as a result of the existing bevel since a progressive increase in height or width of the rib in the radial direction starts before reaching the constant height (hc). The head 31 of the screw will not go through the cavity of the device 200 unless it is pushed with a screwdriver as described below.

Next, holding the device 200 comprising the screw 30 with one hand and holding the handle 41 of the screwdriver 40 with the other hand, the interchangeable tip 41 of the screwdriver 40 is contacted with the head 31 of said screw 30, and said head 31 is pushed thus inserting the head 31, and therefore the screw 30 together with the tip 41 of the screwdriver 40, in the device 200. The pressure of the ribs or fins 210 of the cavity of the device 200 on the screw 30 and on the tool holder 43 and the tip 42 of the screwdriver 40 favors a device-screw-screwdriver assembly that allows the handling thereof as a single element or an integral assembly. This enables being able to place the screw 30 against any surface without the risk of it falling and without needing to hold said screw with one hand in order to be driven in.

The foregoing is possible mainly due to the elasticity and flexibility of the material used for making the holding device 200 combined with the ribs 210 arranged therein which, in addition to allowing deformation of the ribs 210 when a screw 30 and a screwdriver 40 run therein, allows the device 200 to return to its initial shape after deformation thereof when screwing in the screw 30, acting like a spring system that absorbs the differences in diameter between the tool holder 43 and the head 31 of the screw 30 and the interchangeable tip 41. The elasticity of the material allows using one and the same device 200 with screws 30 having head 31 and thread 32 of different diameters, regardless of their length, as well as using same with screwdrivers 40 with different interchangeable tips 42 and tool holder 43 of different diameters.

The operation and use of the device 100 for being used with manual or electric screwdrivers without any tool holder, i.e., without a large variation in diameter between the tip of the screwdriver and the shaft, the screwdriver consisting of a handle, a shaft and a tip, is similar to that described for electric screwdrivers 40.

The material is also preferably an insulating material which allows the use thereof in electrically hazardous places, increasing user safety when working with sockets, for example.

Therefore, due to its mainly flexible and elastic material and configuration, the device object of the invention allows the original shape to be returned the device once it is used so that it can be reused with guaranteed performance due to its elasticity, and the device can be adapted to different elements that are inserted therein due to its flexibility.

Having sufficiently described the nature of the invention as well as two preferred embodiments, it is hereby stated that the materials, shape, size and arrangement of the described elements may be modified, provided that it does not entail an alteration of the essential features of the invention that are claimed below.

1. A holding device for screwing in a screw, having a tubular longitudinal body (100, 200) with a cavity, characterized in that said body (100, 200) is made of an elastic material and comprises longitudinal ribs (110, 210) on the surface of the cavity (150, 250) of the tubular body (100, 200).

2. The device according to claim 1, characterized in that the ribs (110, 210) have a curvature with respect to the surface of the cavity (150, 250).

3. The device according to claim 1, characterized in that the cavity comprises a bottom base (170, 270) having a larger diameter than the top base (160, 260).

4. The device according to claim 1, characterized in that the outer surface (140, 240) of the tubular body (100, 200) comprises three portions: a first bottom portion (143, 243) extending from the bottom base (170, 270) with a constant diameter, a third top portion (141, 241) extending from the top base (160, 260) to the first bottom portion (143, 243), and a second intermediate portion (142, 242) connecting the two preceding portions (141, 241, 143, 243).

5. The device according to claim 4, characterized in that said third top portion (141, 241) is longer than the other two portions and it takes up close to the entire length (140, 240) of the device.

6. The device according to claim 4, characterized in that the third top portion (241) has a constant diameter.

7. The device according to claim 4, characterized in that the third top portion (141) has an increasing diameter from the top base (160) until meeting up with the second intermediate portion (142).

8. The device according to claim 4, characterized in that the surface of the cavity also has three portions that correspond with the portions of the outer surface, the first bottom portion of the cavity being of constant diameter.

9. The device according to claim 1, characterized in that the ribs (110) comprise a variable longitudinal section with a larger section in the central area of the rib (110), with a maximum height (hmax) in the radial direction, than at the top and bottom ends thereof, the free side of each rib therefore determining a curve (c).

10. The device according to claim 1, characterized in that the ribs (210) have a warped fin shape facing the screwing direction of rotation.

11. The device according to claim 1, characterized in that the ribs (110, 210) comprise a longitudinal notch close to the surface of the cavity.

12. The device according to claim 1, characterized in that it has at least 5 ribs.

13. The device according to claim 1, characterized in that the material thereof is an insulating and flexible material.

14. The device according to claim 1, characterized in that it externally has reinforcements (230) that increase the section of the device.
